(19) United States
(12) Patent Application Publication
(10) Pub. No.: US 2009/0024764 A1
(43) Pub. Date: Jan. 22, 2009

(54) Tracking The Physical Location Of A Server In A Data Center

(75) Inventors: Willliam E. Atherton, Hillsborough, NC (US); Richard E. Harper, Chapel Hill, NC (US); William J. Piazza, Holly Springs, NC (US)

Correspondence Address: IBM (RPS-BLF);c/o BIGGERS & OHANIAN, LLP, P.O. BOX 1469, AUSTIN, TX, 78767-1469, US

(73) Assignee: INTERNATIONAL BUSINESS MACHINES CORPORATION, ARMONK, NY (US)

(21) Appl. No.: 11/779,627

(22) Filed: Jul. 18, 2007

(51) Int. Cl. G06F 15/177

(52) U.S. Cl. 709/250

(57) ABSTRACT

Tracking the physical location of a server in a data center including detecting, through a one-wire link between a connector in a cabinet slot and a management module, insertion of the server into a cabinet slot, the server connected upon insertion to a one-wire link through a connector in the cabinet slot and determining, in dependence upon the one-wire link's multiplexer address code, a physical location of the server. The data center includes a plurality of cabinet slots, each cabinet slot having a connector, the data center also includes a presence-detection network, the presence-detection network comprising one-wire links among the cabinet slots and the management module, the one-wire links coupled between the connectors and the management module and multiplexed into the management module according to multiplexer address codes, each one-wire link associated with a separate multiplexer address code, each multiplexer address code associated with a separate physical location.

### BACKGROUND OF THE INVENTION

1. Field of the Invention

The field of the invention is data processing, or, more specifically, methods, apparatus, and products for tracking the physical location of a server in a data center.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

One of the areas in which progress has been made is in tracking the physical location of a server in a data center. Data centers may contain many servers, hundreds or even thousands of servers. Servers may be installed in or removed from a data center from time to time. A server may be removed from a data center for many reasons including, for example, for maintenance or replacement. Data centers that contain many servers may include servers in different physical locations throughout the world. Because servers may be installed in, removed from, or moved to different physical locations in a data center, system administrators track the physical location of a server in the data center as part of managing the data center. Currently methods of tracking the physical location of a server in a data center are difficult and time-consuming.

### SUMMARY OF THE INVENTION

Methods, apparatus, and products for tracking the physical location of a server in a data center, are disclosed that include detecting, by the management module through a one-wire link between a connector in a cabinet slot and the management module, insertion of the server into the cabinet slot, the server connected upon insertion to the one-wire link through the connector in the cabinet slot and determining, by the management module in dependence upon the one-wire link's multiplexer address code, a physical location of the server. In the methods, apparatus, and products for tracking the physical location of a server in a data center, the data center includes a management module and a plurality of cabinet slots, each cabinet slot having a connector, the data center also includes a presence-detection network, the presence-detection network including one-wire links among the cabinet slots and the management module, the one-wire links coupled between the connectors in the cabinet slots and the management module and multiplexed into the management module according to multiplexer address codes, each one-wire link associated with a separate multiplexer address code, each multiplexer address code associated with a separate physical location in the data center.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a front view of an exemplary data center improved for tracking the physical location of a server in the data center according to embodiments of the present invention.

FIG. 2 sets forth a functional block diagram of an exemplary data center that tracks the physical location of a server in the data center according to embodiments of the present invention.

FIG. 3 sets forth a flow chart illustrating an exemplary method for tracking the physical location of a server in a data center according to embodiments of the present invention.

FIG. 4 sets forth a flow chart illustrating a further exemplary method for tracking the physical location of a server in a data center according to embodiments of the present invention.

FIG. 5 sets forth a flow chart illustrating a further exemplary method for tracking the physical location of a server in a data center according to embodiments of the present invention.

FIG. 6 sets forth a flow chart illustrating a further exemplary method for tracking the physical location of a server in a data center according to embodiments of the present invention.

### DETAILED DESCRIPTION OF EXEMPLARY EMBODIMENTS

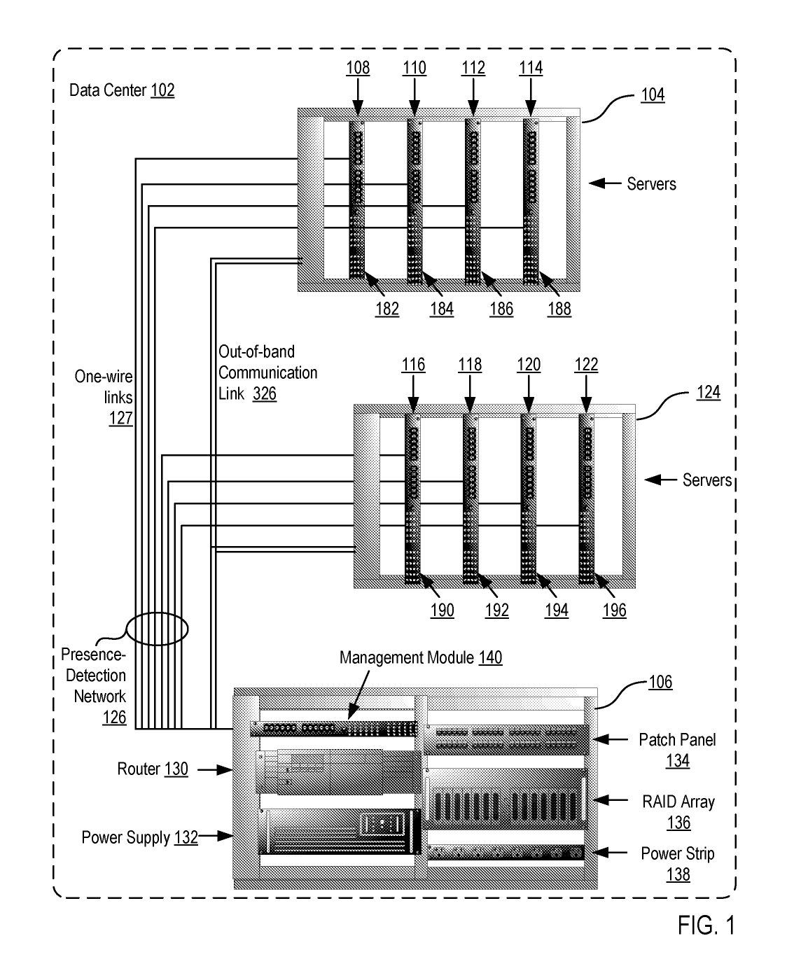

Exemplary methods, apparatus, and products for tracking the physical location of a server in a data center in accordance with the present invention are described with reference to the accompanying drawings, beginning with FIG. 1. FIG. 1 sets forth a front view of an exemplary data center (102) improved for tracking the physical location of a server in the data center according to embodiments of the present invention. The system of FIG. 1 operates generally to track the physical location of a server in the data center according to embodiments of the present invention by detecting, by a management module through a one-wire link between a connector in a cabinet slot and the management module, insertion of the server into the cabinet slot, the server connected upon insertion to the one-wire link through a connector in the cabinet slot, and determining, by the management module in dependence upon the one-wire link's multiplexer address code, a physical location of the server.

A data center useful in tracking the physical location of a server in the data center according to embodiments of the present invention is a facility used for housing electronic equipment such as computers, servers, and data communications equipment. Data centers may occupy one room of a building, one or more floors, or an entire building. Data centers may be configured such that the various cabinet bays that comprise the data center are located in different cities, states, or countries throughout the world. Data centers may include any number of 19-inch rack cabinet bays. A 19-inch rack is a standardized system for mounting various electronic modules in a “stack,” or rack, 19 inches wide. A data center may be implemented in various forms such as, for example, a blade center in which a number of blade servers are installed.

The exemplary data center (102) of FIG. 1 includes three cabinet bays (104,124,106). Cabinet bay (104) contains four servers (182,184,186,188) installed in cabinet slots (108,110,112,114). Cabinet bay (124) also contains four servers (190,192,194,196) installed in cabinet slots (116,118,120,122). Servers in data centers may be installed into cabinet slots or removed from cabinet slots at any time for any reason. Servers may also be moved from one cabinet slot to another cabinet slot. Although only four servers and four cabinet slots are shown in each cabinet bay (104,124), readers of skill in the art will immediately recognize that cabinet bays useful in data centers that track the physical location of a server may include any number of cabinet slots and any number of servers.

In the exemplary system of FIG. 1, each cabinet slot includes a connector (not shown) that connects a server, upon insertion in the cabinet slot, to a presence-detection network (126). Such connectors and presence-detection network may be implemented as part of the backplane of the data center. A presence-detection network is used to detect the presence of a server in a cabinet slot in the data center. Upon insertion into a cabinet slot, a server is connected to the presence-detection network and declares its presence in the cabinet slot through the presence-detection network. The server may declare its presence in the cabinet slot by sending a signal to the management module through the presence-detection network. The presence-detection network includes one-wire links (127) among the cabinet slots (108-122) and a management module (140) installed in cabinet bay (106). The exemplary management module (140) of FIG. 1 is a hot-swappable device that can be used by a system administrator to configure and manage all components installed in the data center (102). The one-wire links (127) of the presence-detection network (126) are coupled between the connectors in the cabinet slots and the management module (140). The one-wire links (127) are multiplexed into the management module (140) according to multiplexer address codes, each one-wire link associated with a separate multiplexer address code. In the system of FIG. 1, each multiplexer address code is also associated with a separate physical location in the data center. Such a physical location may specify any type of physical location useful for tracking a server in a data center. That is, a physical location may specify a general location or a very specific location. A physical location may, for example, specify that a server is located in a particular slot. Alternatively, a physical location may be much more specific and specify that a server is located in a particular cabinet slot, in a cabinet, in a room, in a building, in a city, in a state. The exemplary management module of FIG. 1 tracks the physical location of a server according to embodiments of the present invention by detecting, through the one-wire link (127) between a connector in a cabinet slot and the management module (140), insertion of the server into the cabinet slot, and determining, in dependence upon the one-wire link's multiplexer address code, a physical location of the server.

The management module (140) of FIG. 1 may also transmit to a server its physical location in the data center and retrieve, from the server, an identity of the server through direct out-of-band communications between the server and the management module. The management module of FIG. 1 may transmit, to the server, its physical location in the data center and retrieve a server identity through the out-of-band communications link (326). The out-of-band communications link (326) enables out-of-band communications between the management module (140) and the servers in the cabinet slots. Although the out-of-band communications link (326) is shown here as a two wire bus, readers of skill in the art will recognize that many types of communications links may be useful for such out-of-band communications including, for example, the Inter-Integrated Circuit (‘I²C’) bus, the 1-Wire bus, the Peripheral Component Interconnect (‘PCI’) bus, the system management bus (‘SMB’), serial peripheral interface (‘SPI’), Intelligent platform management bus (‘IPMB’), the universal serial bus (‘USB’), the Infiniband link, and so on. In addition to the management module (140), cabinet bay (106) also contains other electronic equipment useful in data centers. The exemplary cabinet bay (106) contains a power supply (132) for the data center (102), a data communications network router (130), a patch panel (134), a Redundant Array of Independent Disks (‘RAID’) (136), and a power strip (138). The arrangement of electronic equipment in the example data center of FIG. 1, the power supply, RAID array, servers, and other devices making up the exemplary system illustrated in FIG. 1, are for explanation, not for limitation. Data centers useful for tracking the physical location of a server according to various embodiments of the present invention may include additional servers, routers, and other devices, not shown in FIG. 1, as will occur to those of skill in the art. Various embodiments of the present invention may be implemented on a variety of hardware platforms in addition to those illustrated in FIG. 1.

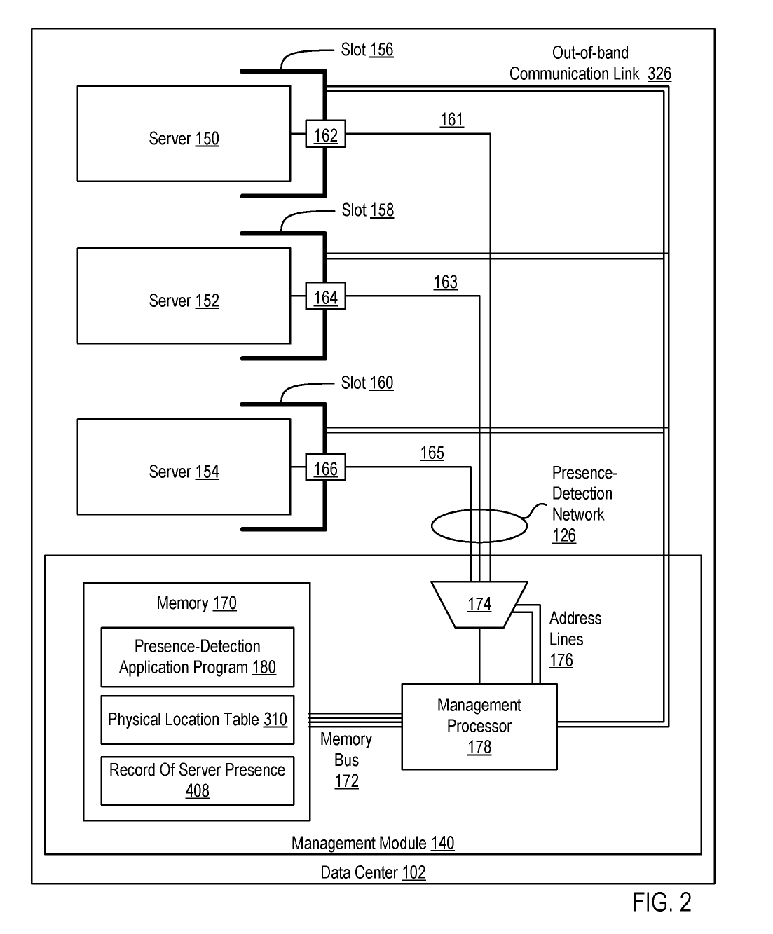

For further explanation, FIG. 2 sets forth a functional block diagram of an exemplary data center (102) that tracks the physical location of a server in the data center according to embodiments of the present invention. The data center of FIG. 2 includes a management module (140), a hot-swappable device that can be used by a system administrator to configure and manage all components installed in the data center (102). The management module (140) of FIG. 2 includes a management processor (178) connected through a memory bus (172) to computer memory (170). The management module also includes a multiplexer (174) that connects the management processor (178) and management module (140) to the cabinet slots (156,158,160) through the presence-detection network (126). In the system of FIG. 2 the multiplexer (174) is shown as part of the management module (140) for illustration only but readers of skill in the art will recognize that the multiplexer (174) may alternatively be implemented as part of the backplane of the data center (102).

The exemplary data center (102) of FIG. 2 also includes a plurality of cabinet slots (156,158,160), each cabinet slot having a connector (162,164,166). The connectors (162,164,166) connect a server, upon insertion in the cabinet slot, to a presence-detection network (126). Such connectors and presence-detection network may be implemented as part of the backplane of the data center (102). The presence-detection network (126) of FIG. 2 includes one-wire links (322) among the cabinet slots (316) and the management module (140), the one-wire links (161,163,165) coupled between the connectors (162,164,166) in the cabinet slots (156,158,160) and the management module (140). The one-wire links (161,163,165) are multiplexed, by multiplexer (174), into the management module (140) according to multiplexer address codes. Each one-wire link (161,163,165) in FIG. 2 is associated with a separate multiplexer address code. A multiplexer is a device that selects one of many inputs to output in a single channel. An input to a multiplexer may be selected as the multiplexer's output by using an address code. That is, each input is associated with a unique address code that can be used to select the input as the multiplexer's output. In the system of FIG. 2, for example, the one-wire links are inputs to the multiplexer (174) and each one-wire link is associated with a unique multiplexer address code. The management processor (178) may select any one of the one-wire links as an input to the multiplexer (174) by using the multiplexer address code associated with the one-wire link through address lines (176). In the system of FIG. 2, each multiplexer address code is also associated, in the physical location table (310) stored in computer memory (170), with a separate physical location in the data center. Such a physical location may specify any type of physical location useful for tracking a server in a data center. That is, a physical location may specify a general location or a very specific location. A physical location may, for example, specify that a server is located in a particular slot. Alternatively, a physical location may be much more specific and specify that a server is located in a particular cabinet slot, in a cabinet, in a room, in a building, in a city, in a state.

Stored in computer memory (170) in the system of FIG. 2 is a presence-detection application program (180), a module of computer program instructions that tracks the physical location of server in a data center according to embodiments of the present invention by causing the management processor to detect, through a one-wire link between a connector in a cabinet slot and the management module (140), insertion of the server into the cabinet slot and determine, in dependence upon the one-wire link's multiplexer address code, a physical location of the server. The management module (140) may detect insertion of the server into the cabinet slot by periodically scanning each multiplexer address code to determine server presence in the physical location associated with the multiplexer address code, maintaining for the physical location a record of server presence and, if the scan indicates server presence in the physical location and the record indicates no server presence in the physical location, determining that the server has been inserted into the physical location at a time after a previous scan and updating the record of server presence to indicate server presence in the physical location. Consider, for example, that the exemplary server (150) of FIG. 2 has been recently inserted into cabinet slot (156). Upon insertion the server (150) is connected to the presence-detection network (126) through the connector (162) in the cabinet slot (156). The server declares its presence in the slot by sending a signal through the presence-detection network on the one-wire link (161) to the management module (140). The management module (140) may then detect the insertion of the server (150) into the cabinet slot (156) by periodically scanning each multiplexer address code to determine server presence in the physical location associated with the multiplexer address code. When the management module scans the multiplexer address code associated with the one-wire link (161), the scan indicates that a server is present in the cabinet slot (162). A scan indicates that a server is present in the cabinet slot (162) if the management module detects that a signal is present on the one-wire link associated with scanned multiplexer address code. Because the server (150) has only recently been installed in the cabinet slot (162), the record (408) of server presence maintained by the management module (140) indicates that no server is present in the physical location associated with the multiplexer address code. When the scan indicates that a server is present in the cabinet slot (162) and the record indicates that no server is present in the cabinet slot (162), the management module determines that the server (150) has been inserted into the physical location, cabinet slot (162), at a time after a previous scan and the management module (140) updates the record (408) of server presence to indicate server presence in the physical location.

After the management module detects the insertion of the server into the cabinet slot the management module then determines, in dependence upon the one-wire link's multiplexer address code, a physical location of the server. In the system of FIG. 2, physical locations are associated with multiplexer address codes in the physical location table (310). That is, each multiplexer address code is associated with a separate physical location in the data center (102). The management module may determine a physical location of the server by using the one-wire link's multiplexer address code to find the physical location associated with the one-wire link's multiplexer address code in the physical location table (310).

The management module (140) of FIG. 2 may also transmit to a server its physical location in the data center and retrieve, from the server, an identity of the server through direct out-of-band communications between the server and the management module. The management module (140) of FIG. 2 may transmit, to the server, its physical location in the data center and retrieve a server identity through the out-of-band communications link (326). The out-of-band communications link (326) enables out-of-band communications between the management module (140) and the servers in the cabinet slots. Although the out-of-band communications link (326) is shown here as a two wire bus, readers of skill in the art will recognize that many types of communications links may be useful for such out-of-band communications including, for example, the Inter-Integrated Circuit (‘I²C’) bus, the 1-Wire bus, the Peripheral Component Interconnect (‘PCI’) bus, the System Management Bus (‘SMB’), serial peripheral interface (‘SPI’), Intelligent platform management bus (‘IPMB’), the universal serial bus (‘USB’), the Infiniband link, and so on.

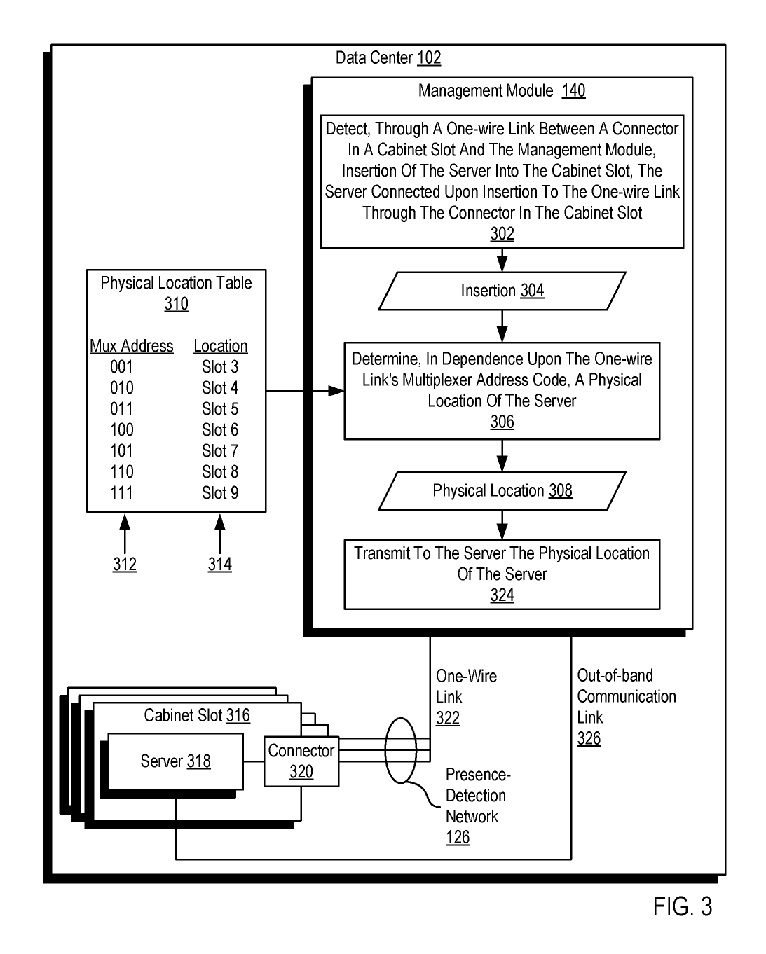

For further explanation, FIG. 3 sets forth a flow chart illustrating an exemplary method for tracking the physical location of a server (318) in a data center (102) according to embodiments of the present invention. In the method of FIG. 3 the data center (102) includes a plurality of cabinet slots (316), each cabinet slot having a connector (320). The connector (320) connects a server (318), upon insertion in the cabinet slot (316), to a presence-detection network (126). Such connectors and presence-detection network may be implemented as part of the backplane of the data center (102). The exemplary presence-detection network (102) of FIG. 3 includes one-wire links (322) among the cabinet slots (316) and the management module (140). The one-wire links (322) of FIG. 3 are coupled between the connectors (320) in the cabinet slots (316) and the management module (140) and are multiplexed into the management module (140) according to multiplexer address codes (312). As described above, each one-wire link (322) is associated with a separate multiplexer address code (312). Each multiplexer address code (312) is associated with a separate physical location (314) in the data center (102). Such a physical location may specify any type of physical location useful for tracking a server in a data center. That is, a physical location may specify a general location or a very specific location. A physical location may, for example, specify that a server is located in a particular slot. Alternatively, a physical location may be much more specific and specify, for example, that a server is located in a particular cabinet slot, in a cabinet, in a room, in a building, in a city, in a state.

The exemplary data center of FIG. 3 also includes a management module (140). The management module of FIG. 3 tracks the physical location of a server in a data center by detecting (302), through a one-wire link (322) between a connector (320) in a cabinet slot (316) and the management module (140), insertion (304) of the server (318) into the cabinet slot (316), and determining (306), in dependence upon the one-wire link's (322) multiplexer address code (312), a physical location (308) of the server (318). In the method of FIG. 3 the physical location table (310) includes two columns, a column representing multiplexer address codes (312) and a column representing physical locations (314) in the data center (102). The physical locations (314) in the physical location table (310) of FIG. 3 specify cabinet slot numbers in the data center (102) for illustration only, but readers of skill in the art will recognize that physical locations used in tracking the physical location of a server in a data center according to embodiments of the present invention be more specific in describing the physical location of server in the data center.

The method of FIG. 3 also includes transmitting (324), by the management module (140) to the server (318), the physical location (308) of the server (318). When the physical location of the server is transmitted to the server, a system administrator may query the server for its physical location in the data center. The transmission of the physical location to the server may be transparent with respect to the server's application layer. That is, management module may transmit the physical location of the server through any out-of-band communications link (326). The out-of-band communications link (326) enables out-of-band communications between the management module (140) and the server (318) in the cabinet slot (316). Types of communications links useful for such out-of-band communications include:
I²C bus, a serial computer bus invented by Philips that is used to for low-speed communications with peripheral components of a system. The name stands for Inter-Integrated Circuit and is pronounced I-squared-C or sometimes as I-two-C.
1-Wire bus, a device communications bus system designed by Dallas Semiconductor that provides low-speed data, signaling and power over a single wire, in addition to a ground wire. 1-Wire is similar in concept to I²C, but with lower data rates and a much lower cost. It is typically used to communicate with small inexpensive devices.
System Management Bus (‘SMB’), a two-wire bus used for communication with low-bandwidth devices on a motherboard, especially power related chips. Other devices might include temperature sensors and lid switches. A device can provide manufacturer information, indicate its model/part number, save its state for a suspend event, report errors, accept control parameters, and return status using SMB.
Serial Peripheral Interface (‘SPI’) Bus, a synchronous serial data link standard named by Motorola that operates in full duplex mode. Devices communicate in master/slave mode where the master device initiates the data frame. Multiple slave devices are enabled using separate select lines.
Intelligent platform management bus (‘IPMB’), an enhanced implementation of I²C, the IPMB connects a baseboard management controller to other controllers for communication via the intelligent platform management interface (‘IPMI’) specification. The IPMI specification defines a set of common interfaces to computer hardware and firmware which system administrators can use to monitor system health and manage the system.
Peripheral Component Interconnect (‘PCI’) bus, a computer bus for attaching peripheral devices to a computer motherboard. PCI devices can be implemented as an integrated circuit fitted onto the motherboard itself, called a planar device in the PCI specification, or as an expansion card that fits into a socket.
The Universal Serial Bus (‘USB’), a serial bus standard for communications designed to allow a peripheral to be connected without an expansion cards, and to improve plug-and-play capabilities by allowing devices to be hot-swapped. Originally designed for computers, its flexibility has placed USB buses on video game consoles, PDAs, portable DVD and media players, cell phones, and even devices such as televisions, home stereo equipment, digital audio players, car stereos, and portable memory devices.
Inifiniband link, a point-to-point, bidirectional serial link intended for the connection of processors with high speed peripherals such as storage devices. InfiniBand is the result of merging two competing designs, Future I/O, developed by Compaq, IBM, and Hewlett-Packard, with Next Generation I/O (ngio), developed by Intel, Microsoft, and Sun. From the Compaq side, the roots were derived from Tandem's ServerNet. For a short time before the group came up with a new name, InfiniBand was called System I/O.
Others as will occur to those of skill in the art.

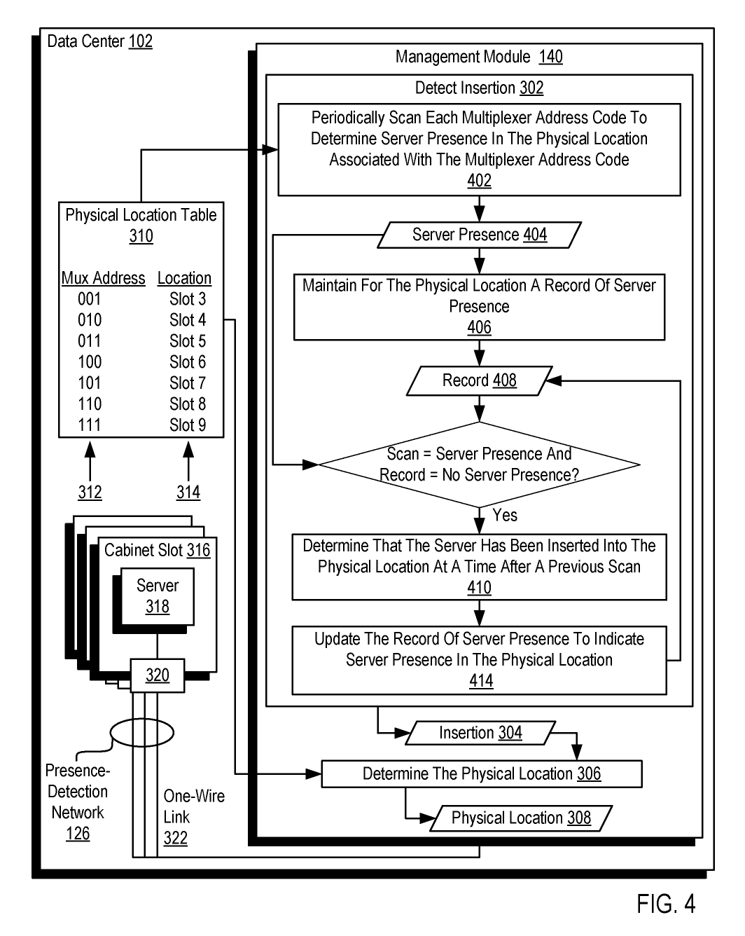

For further explanation, FIG. 4 sets forth a flow chart illustrating a further exemplary method for tracking the physical location of a server in a data center according to embodiments of the present invention. The method of FIG. 4 is similar to the method of FIG. 3 including, as it does, the management module's (140) detecting (302) insertion (304) of the server (318) into the cabinet slot (316) and the management module's (140) determining (306) a physical location (308) of the server (318), all of which operate as described above.

In the method of FIG. 4, however, detecting (302) insertion (304) of the server (318) into the cabinet slot (316) includes periodically scanning (402) each multiplexer address code (312) to determine server presence (404) in the physical location (314) associated with the multiplexer address code (312) and maintaining (406) for the physical location (314) a record (408) of server presence. Scanning each multiplexer address code may be carried out continuously at periodic time intervals. All multiplexer address codes may be scanned, for example, once a minute, once an hour, once a week, and so on. The scan (402) may indicate server presence if the management module detects that a signal is present on the one-wire link coupled from the connector in the cabinet slot to the management module. A server having a physical location that can be tracked according to embodiments of the present invention may be configured, for example, such that upon insertion in the cabinet slot, the server will apply a logic high signal through the presence-detection network on the one-wire link coupling the connector in the cabinet slot in which the server is inserted to the management module. When scanning the multiplexer address code associated with that one-wire link, the management module will detect the logic high signal present on the one-wire link. Such a scan indicates that a server is present in the physical location associated with the multiplexer address code. The management module then maintains a record of server presence in the physical location associated with the multiplexer address code. The management module maintains the record of server presence by indicating in the record whether a server is present in the physical location associated with the multiplexer address code. The record of server presence may be implemented as any data structure useful for storing information describing server presence, such as for example, a table, a linked list, an array, or any other data structure as will occur to those of skill in the art.

If the scan (402) indicates server presence in the physical location (314) and the record (408) indicates no server presence in the physical location (316), detecting (302) insertion (304) of the server (318) into the cabinet slot (316) also includes determining (410) that the server (318) has been inserted into the physical location (314) at a time after a previous scan and updating (414) the record (408) of server presence to indicate server presence in the physical location. The management module (140) compares the results of the scan of the multiplexer address code to the record of server presence in the physical location. If, during a scan of a multiplexer address code, the management module detects that a signal is present on the one-wire link associated with the multiplexer address code, the scan indicates server presence in the physical location associated with the multiplexer address code. The management module then compares that indication with the record of server presence. If the record of server presence indicates that no server is present in the physical location associated with the multiplexer address code, the management module determines that the server has been inserted into the physical location at a time after a previous scan. That is, the management module determines that a server has been inserted into a previously vacant cabinet slot. The management module then updates the record to indicate that a server is present in the physical location associated with the multiplexer address code.

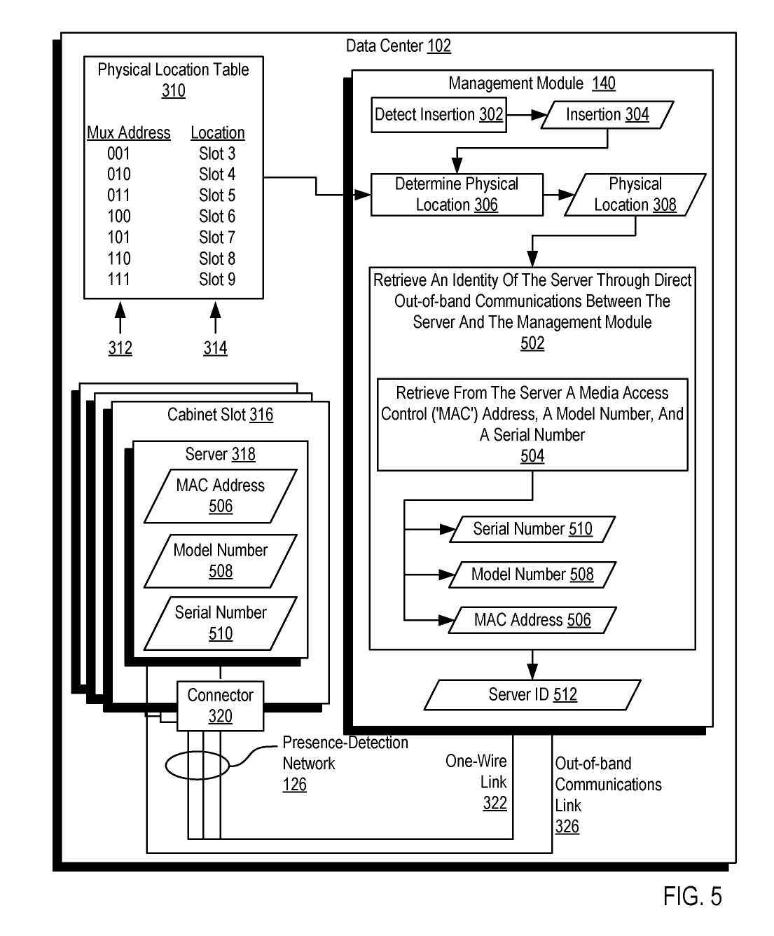

For further explanation, FIG. 5 sets forth a flow chart illustrating a further exemplary method for tracking the physical location of a server in a data center according to embodiments of the present invention. The method of FIG. 5 is similar to the method of FIG. 3 including, as it does, the management module's (140) detecting (302) insertion (304) of the server (318) into the cabinet slot (316) and the management module's (140) determining (306) a physical location (308) of the server (318), all of which operate as described above.

The method of FIG. 5, however, also includes retrieving (502), by the management module (140) from the server (318), an identity (512) of the server (318) through direct out-of-band communications between the server (318) and the management module (140). In the method of FIG. 5 such out-of-band communications may be carried out through the out-of-band communications link (326). The out-of-band communications link (326) enables out-of-band communications between the management module (140) and the server (318) in the cabinet slot (316). Types of communications links useful for such out-of-band communications include the I²C bus, the 1-Wire bus, the PCI bus, SMB, SPI, IPMB, USB, the Infiniband link, and others as will occur to those of skill in the art. In the method of FIG. 5, retrieving (502) an identity (512) of the server (318) is carried out by retrieving (504) from the server (318) a Media Access Control (‘MAC’) address (504), a model number (508), and a serial number (510). A MAC address is a quasi-unique identifier attached to a network adapter in a server. The MAC address can be used to uniquely identify the server in the data center. MAC addresses also enable data communication frames to be marked for delivery to specific servers. Servers may also be identified by model numbers and serial numbers. Model numbers identify the type of the server. Servers having the same model numbers generally have similar characteristics and configurations, such as hardware or software configurations. Model numbers may be used to identify such characteristics and configurations of a server in the cabinet slot. A serial number is another form of unique identification for a server. Serial numbers may be assigned by the manufacturer of a server or by a system administrator. Serial numbers may be used for many reasons including, for example, for maintaining maintenance records. Although only three types of server identification are described here, readers of skill in the art will recognize that many other types of server identification useful in systems that track the physical location of a server in a data center according to embodiments of the present invention may be used and each such type of server identification is well within the scope of the present invention.

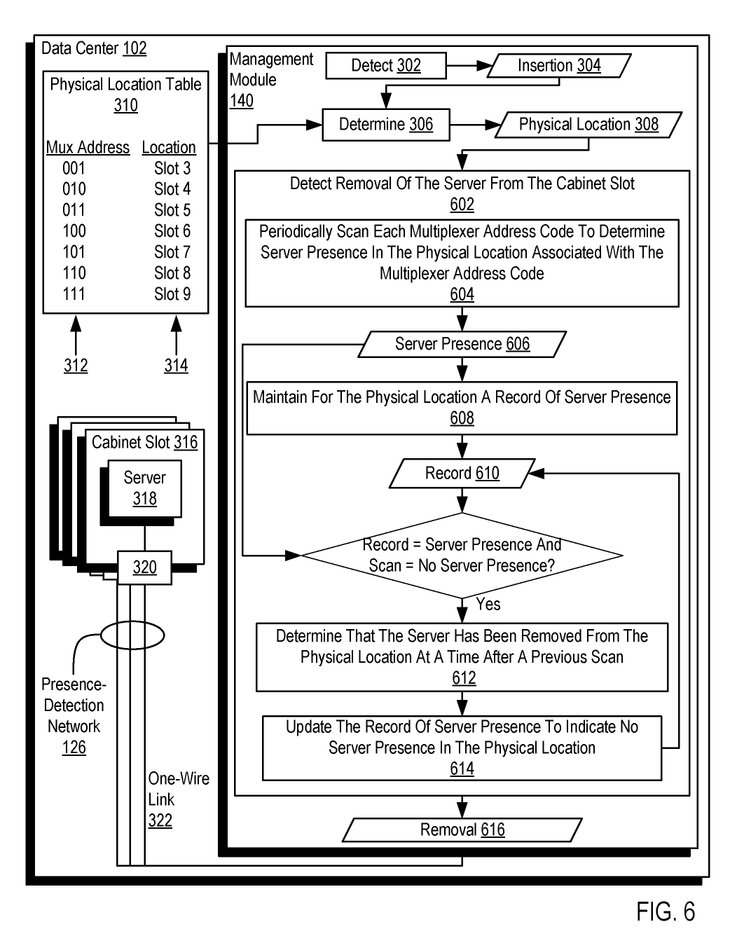

For further explanation, FIG. 6 sets forth a flow chart illustrating a further exemplary method for tracking the physical location of a server in a data center according to embodiments of the present invention. The method of FIG. 6 is similar to the method of FIG. 3 including, as it does, the management module's (140) detecting (302) insertion (304) of the server (318) into the cabinet slot (316) and the management module's (140) determining (306) a physical location (308) of the server (318), all of which operate as described above.

The method of FIG. 6, however, also includes detecting (602), by the management module (140) through the one-wire link (322) between the connector (320) in the cabinet slot (316) and the management module (140), removal (616) of the server (318) from the cabinet slot (316). In the method of FIG. 6, detecting (602) removal (616) of the server (318) from the cabinet slot (316) includes periodically scanning (604) each multiplexer address code (312) to determine server presence (606) in the physical location (314) associated with the multiplexer address code (312) and maintaining (608), for the physical location (314), a record (610) of server presence. Scanning each multiplexer address code may be carried out continuously at periodic time intervals. All multiplexer address codes may be scanned, for example, once a minute, once an hour, once a week, and so on. The scan (604) may indicate no server presence if the management module detects no signal is present on the one-wire link coupled from the connector in the cabinet slot to the management module. A server useful in the tracking of its physical location according to embodiments of the present invention may be configured, for example, such that while inserted in a cabinet slot, the server applies a logic high signal through the presence-detection network on the one-wire link coupling the connector in the cabinet slot in which the server is inserted to the management module. When the server is removed from the cabinet slot the logic high signal on the one-wire link is also removed. That is, when a server is removed from a cabinet slot no signal is sent through the network on the one-wire link. When scanning the multiplexer address code associated with that one-wire link, the management module will detect that no signal is present on the one-wire link. Such a scan indicates that there is no server present in the physical location associated with that one wire link's multiplexer address code. The management module then maintains a record of server presence in the physical location associated with the multiplexer address code. The management module maintains the record of server presence by indicating in the record whether a server is present in the physical location associated with the multiplexer address code. The record of server presence may be implemented as any data structure useful for storing information describing server presence, such as for example, a table, a linked list, an array, or any other data structure as will occur to those of skill in the art.

If the record (610) indicates server presence in the physical location and the scan (604) indicates no server presence in the physical location (314), detecting (602) removal (616) of the server (318) from the cabinet slot (316) also includes determining (612) that the server (318) has been removed from the physical location (314) at a time after a previous scan and updating (614) the record (610) of server presence to indicate no server presence in the physical location (314). The management module (140) compares the results of the scan of the multiplexer address code to the record of server presence in the physical location. If, during a scan of a multiplexer address code, the management module does not detect a signal present on the one-wire link associated with the multiplexer address code, the scan indicates no server presence in the physical location associated with the multiplexer address code. The management module then compares that indication of no server presence with the record of server presence. If the record of server presence indicates that a server is present in the physical location associated with the multiplexer address code, the management module determines that the server has been removed from the physical location at a time after a previous scan. That is, the management module determines cabinet slot previously containing the server is now vacant. The management module then updates the record to indicate that no server is present in the physical location associated with the multiplexer address code.

Exemplary embodiments of the present invention are described largely in the context of a fully functional computer system for tracking the physical location of a server in a data center. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of tracking the physical location of a server in a data center, the data center comprising a management module, the data center further comprising a plurality of cabinet slots, each cabinet slot having a connector, the data center further comprising a presence-detection network, the presence-detection network comprising one-wire links among the cabinet slots and the management module, the one-wire links coupled between the connectors in the cabinet slots and the management module and multiplexed into the management module according to multiplexer address codes, each one-wire link associated with a separate multiplexer address code, each multiplexer address code associated with a separate physical location in the data center, the method comprising:
detecting, by the management module through a one-wire link between a connector in a cabinet slot and the management module, insertion of the server into the cabinet slot, the server connected upon insertion to the one-wire link through the connector in the cabinet slot; and
determining, by the management module in dependence upon the one-wire link's multiplexer address code, a physical location of the server.

2. The method of claim 1 wherein detecting insertion of the server into the cabinet slot further comprises:
periodically scanning each multiplexer address code to determine server presence in the physical location associated with the multiplexer address code;
maintaining for the physical location a record of server presence; and
if the scan indicates server presence in the physical location and the record indicates no server presence in the physical location:
determining that the server has been inserted into the physical location at a time after a previous scan; and
updating the record of server presence to indicate server presence in the physical location.

3. The method of claim 1 further comprising retrieving, by the management module from the server, an identity of the server through direct out-of-band communications between the server and the management module.

4. The method of claim 3 wherein retrieving an identity of the server further comprises retrieving from the server a Media Access Control (‘MAC’) address, a model number, and a serial number.

5. The method of claim 1 further comprising detecting, by the management module through the one-wire link between the connector in the cabinet slot and the management module, removal of the server from the cabinet slot including:
periodically scanning each multiplexer address code to determine server presence in the physical location associated with the multiplexer address code;
maintaining, for the physical location, a record of server presence; and
if the record indicates server presence in the physical location and the scan indicates no server presence in the physical location:
determining that the server has been removed from the physical location at a time after a previous scan; and
updating the record of server presence to indicate no server presence in the physical location.

6. The method of claim 1 further comprising transmitting, by the management module to the server, the physical location of the server.

7. Apparatus for tracking the physical location of a server in a data center, the data center comprising a management module, the data center further comprising a plurality of cabinet slots, each cabinet slot having a connector, the data center further comprising a presence-detection network, the presence-detection network comprising one-wire links among the cabinet slots and the management module, the one-wire links coupled between the connectors in the cabinet slots and the management module and multiplexed into the management module according to multiplexer address codes, each one-wire link associated with a separate multiplexer address code, each multiplexer address code associated with a separate physical location in the data center, the apparatus comprising a computer processor, a computer memory operatively coupled to the computer processor, the computer memory having disposed within it computer program instructions capable of:
detecting, by the management module through a one-wire link between a connector in a cabinet slot and the management module, insertion of the server into the cabinet slot, the server connected upon insertion to the one-wire link through the connector in the cabinet slot; and
determining, by the management module in dependence upon the one-wire link's multiplexer address code, a physical location of the server.

8. The apparatus of claim 7 wherein detecting insertion of the server into the cabinet slot further comprises:
periodically scanning each multiplexer address code to determine server presence in the physical location associated with the multiplexer address code;
maintaining for the physical location a record of server presence; and
if the scan indicates server presence in the physical location and the record
indicates no server presence in the physical location:
determining that the server has been inserted into the physical location at a time after a previous scan; and
updating the record of server presence to indicate server presence in the physical location.

9. The apparatus of claim 7 further comprising computer program instructions capable of retrieving, by the management module from the server, an identity of the server through direct out-of-band communications between the server and the management module.

10. The apparatus of claim 9 wherein retrieving an identity of the server further comprises retrieving from the server a Media Access Control (‘MAC’) address, a model number, and a serial number.

11. The apparatus of claim 7 further comprising computer program instructions capable of detecting, by the management module through the one-wire link between the connector in the cabinet slot and the management module, removal of the server from the cabinet slot including:
periodically scanning each multiplexer address code to determine server presence in the physical location associated with the multiplexer address code;
maintaining, for the physical location, a record of server presence; and
if the record indicates server presence in the physical location and the scan indicates no server presence in the physical location:
determining that the server has been removed from the physical location at a time after a previous scan; and
updating the record of server presence to indicate no server presence in the physical location.

12. The apparatus of claim 7 further comprising computer program instructions capable of transmitting, by the management module to the server, the physical location of the server.

13. A computer program product for tracking the physical location of a server in a data center, the data center comprising a management module, the data center further comprising a plurality of cabinet slots, each cabinet slot having a connector, the data center further comprising a presence-detection network, the presence-detection network comprising one-wire links among the cabinet slots and the management module, the one-wire links coupled between the connectors in the cabinet slots and the management module and multiplexed into the management module according to multiplexer address codes, each one-wire link associated with a separate multiplexer address code, each multiplexer address code associated with a separate physical location in the data center, the computer program product disposed in a computer readable, signal bearing medium, the computer program product comprising computer program instructions capable of:
detecting, by the management module through a one-wire link between a connector in a cabinet slot and the management module, insertion of the server into the cabinet slot, the server connected upon insertion to the one-wire link through the connector in the cabinet slot; and
determining, by the management module in dependence upon the one-wire link's multiplexer address code, a physical location of the server.

14. The computer program product of claim 13 wherein the signal bearing medium comprises a recordable medium.

15. The computer program product of claim 13 wherein the signal bearing medium comprises a transmission medium.

16. The computer program product of claim 13 wherein detecting insertion of the server into the cabinet slot further comprises:
periodically scanning each multiplexer address code to determine server presence in the physical location associated with the multiplexer address code;
maintaining for the physical location a record of server presence; and
if the scan indicates server presence in the physical location and the record indicates no server presence in the physical location:
determining that the server has been inserted into the physical location at a time after a previous scan; and
updating the record of server presence to indicate server presence in the physical location.

17. The computer program product of claim 13 further comprising computer program instructions capable of retrieving, by the management module from the server, an identity of the server through direct out-of-band communications between the server and the management module.

18. The computer program product of claim 17 wherein retrieving an identity of the server further comprises retrieving from the server a Media Access Control (‘MAC’) address, a model number, and a serial number.

19. The computer program product of claim 13 further comprising computer program instructions capable of detecting, by the management module through the one-wire link between the connector in the cabinet slot and the management module, removal of the server from the cabinet slot including:
periodically scanning each multiplexer address code to determine server presence in the physical location associated with the multiplexer address code;
maintaining, for the physical location, a record of server presence; and
if the record indicates server presence in the physical location and the scan indicates no server presence in the physical location:
determining that the server has been removed from the physical location at a time after a previous scan; and
updating the record of server presence to indicate no server presence in the physical location.

20. The computer program product of claim 13 further comprising computer program instructions capable of transmitting, by the management module to the server, the physical location of the server.
